(19) United States
(12) Patent Application Publication
(10) Pub. No.: US 2017/0192457 A1
(43) Pub. Date: Jul. 6, 2017

(54) TOUCH PANLE, HAPTICS TOUCH DISPLAY USING SAME, AND MANUFACTURING METHOD FOR MAKING SAME

(71) Applicants: Niels Christian Roemer Holme, Farum (DK); Peter Krohne Nielsen, Farum (DK)

(72) Inventors: Niels Christian Roemer Holme, Farum (DK); Peter Krohne Nielsen, Farum (DK)

(73) Assignee: AAC Technologies Pte. Ltd., Singapore (SG)

(21) Appl. No.: 14/985,562

(22) Filed: Dec. 31, 2015

(51) Int. Cl. G06F 1/16; G06F 3/041

(52) U.S. Cl. CPC G06F 1/1626; G06F 1/169; G06F 3/041; G06F 2203/04103

(57) ABSTRACT

A touch panel includes a tactile overlay made of glass material, the tactile overlay having a tactile element configured a ridge or a convex shaped hot-embossed by a TaC-coated tungsten carbide mold. The tactile elements are grinded permanent and scratch resistant by the TaC-coated tungsten carbide mold that allows a user to identify the individual tactile elements sensitively blindly.

### FIELD OF THE INVENTION

The present invention is related to a user interface device provided with surface haptic sensations, and particularly to a touch panel for generating tactile feedback.

### DESCRIPTION OF RELATED ART

“Intelligent” portable electronic devices, such as smart phones, tablet computers, and the like, are becoming increasingly powerful computational tools. Moreover, these devices are becoming more prevalent in today's society. For example, not too long ago a mobile phone was a simplistic device with a twelve-key keypad that only made telephone calls. Today, “smart” phones, tablet computers, personal digital assistants, and other portable electronic devices not only make telephone calls, but also manage address books, maintain calendars, play music and videos, display pictures, and surf the web.

Some display screens can also be used as a touch based input component. These touchscreens are capable of displaying various text and graphics to a user, which the user can select by touching the touchscreen. More specifically, touchscreens can be configured to display virtual buttons and other types of options to the user. While the emergence of mainstream touch display computing has presented usability benefits for many computer users, people with visual impairments often experience significant challenges when interacting with touch display user interfaces. A major feature of touch display is their ability to enable to directly manipulate information with their fingertips, but this capability often presents challenges to blind users, who cannot see or feel the visual information presented.

Fortunately, many mainstream touch display devices now provide tactile feedback for blind and visually impaired users. U.S. Pat. No. 7,148,875 discloses a haptic feedback device for touchpads and other touch controls wherein haptic feedback is provided by direct application of a force or motion to a touch display in a manner that the user's finger can feel the force or motion. To this end, one or more actuators are coupled to the touchpad to apply a force directly to touch display surface. In one embodiment, the actuator comprises a piezoelectric actuator, a voice coil, a pager motor, or a solenoid coupled to the touchpad. Currently, touch panels can be tracked and used on most imaging-based touch display systems. While some touch panels include a tactile overlay may be made of transparent materials, such as clear acrylic plastic, so that touch panels are quite slippery on the touch surface. Damaged by long use, the touch surface of the touch panel is badly abrasion and almost illegible so as to cause visual impair users loss or damage.

In view of the above-described situation, it is necessary to provide an improved touch panel for solving the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a front view of a mobile phone with a touch panel in accordance with an exemplary embodiment of the present invention.

FIG. 2 is a schematic of the touch panel of the mobile phone in FIG. 1.

FIG. 3 is an isometric view of a tactile overlay for the touch panel in FIG. 2.

FIG. 4 is a schematic cross-sectional view of a mold for manufacturing a tactile overlay for the touch panel in FIG. 2.

### DETAILED DESCRIPTION OF THE EMBODIMENT

Reference will now be made to describe an exemplary embodiment of the present disclosure in detail.

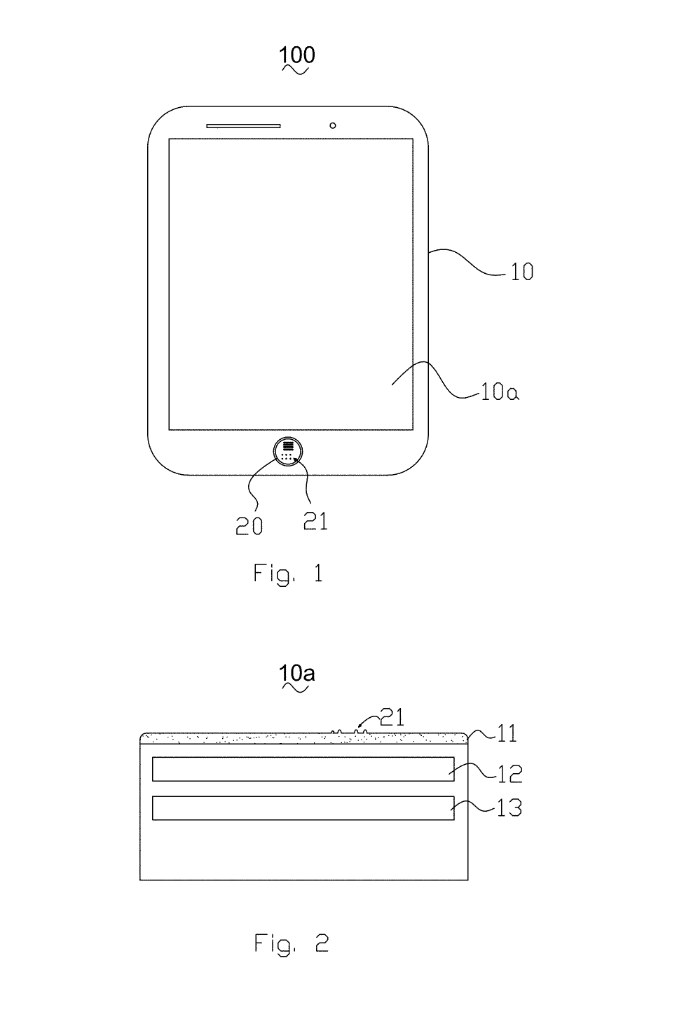

Referring to FIG.1, FIG. 1 illustrates a front view of a mobile phone 100 in accordance with an exemplary embodiment of the present disclosure. The mobile phone 100 comprises a user interface having a housing 10, a touch panel 10a, a main button 20. The phone 100 according to the first exemplary embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular.

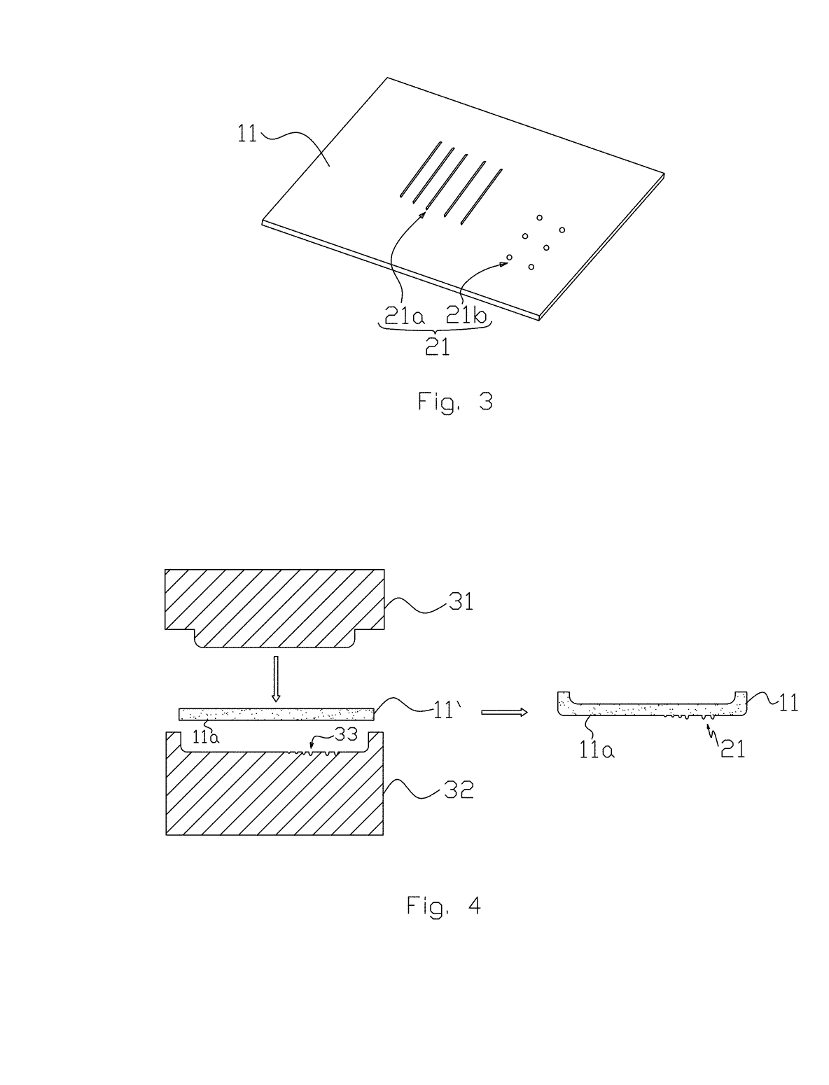

As shown in FIGS. 2 through 3, the present disclosure provides the touch panel 10a optionally with a display unit 13, a touch panel 12 and a tactile overlay 11. The display unit 13 is used for outputting status information generated during the operation of the mobile phone 100 such as image data, key manipulation and function setting of the user. The touch panel 12 serves as an input device receiving the touch input by users. The touch panel 12 is optionally mounted on the whole surface of the display unit 13, and detects change of physical amount generated by the touch of the user, converts the change of physical amount caused by the touch into a touch signal, and transmits the touch signal to control unit of the mobile phone 100. The touch panel 12 may be a pressure type touch panel using a pressure sensor, a resistive touch panel, capacitive touch panel, a surface acoustic wave touch panel, an infrared touch panel, or an inductive touch panel. Since principles of operating the touch panels 12 are already known to those skilled in the art, the descriptions according thereto will be omitted herein. The tactile overlay 11 is formed of a transparent material such as smooth glass which totally covers a front surface of the mobile phone 100. The tactile overlay 11 may protect the touch panel 12 and the display unit 13 and allow data displayed on the touch panel 10a to be seen therethrough. The tactile overlay 11 further includes a tactile element 21 imprinted a smooth outside surface 11a so as to be touched by fingers. The tactile element 21 has a first tactile element 21a configured to be a ridge and a second tactile element 21b configured to be a convex shape. The shape of the tactile element 21 is not restricted to the ridge or the convex shape as described herein. The tactile element 21 may be cut into any shape desired and preferably are of a shape corresponding to the respective control icon displayed on the tactile overlay 11 over which each tactile element 22 will be positioned. Additionally, the tactile elements may be used to identify the position of control icons generated by any application or program.

Due to properties of the tactile overlay 11 made of glass material, in the present disclosure the tactile overlay 11 with the tactile elements 21 are imprinted or hot-embossed by a TaC (Tetrahedral Amorphous Carbon)-coated tungsten carbide mold. Hot-Embossing is a very versatile replication method which uses high pressure and elevated temperature to transfer the structures from the master into the polymer. So, the tactile elements 21 are grinded permanent and scratch resistant by the TaC-coated tungsten carbide mold.

As shown in FIG. 4, the TaC-coated tungsten carbide mold includes a upper mold 31 and a substrate mold 32 corresponding to the upper mold 31. A tactile features 33 corresponding to the tactile elements 21 are provided on the substrate mold 32. A method for fabricating the tactile overlay 11 with the tactile elements 21 comprising the steps of: providing a glass pressing member 11′ with a pressing surface 11a having a predetermined shape; providing a TaC-coated tungsten carbide mold including a upper mold 31 and a substrate mold 32 with a tactile features 33; hot-embossing the pressing member 11′ thereby obtaining a tactile overlay 11 with a tactile element 21 corresponding to the tactile features 33; separating the tactile overlay 11 from the TaC-coated tungsten carbide mold.

By performing the present method, the tactile overlay 11 with the tactile element 21 can be mass-produced. In addition, most of conventional necessary ultra-precision machining steps are obviated, tactile elements integrated imprinted on the tactile overlay 11 made of glass material by virtue of hot-embossing technology. Thus the manufacturing cost is reduced greatly.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A touch panel, comprising:
a display unit;
a touch panel;
a tactile overlay made of glass material for protecting the touch panel and the display unit, and for allowing data displayed on the touch panel, the tactile overlay having an smooth outside surface, and a tactile element hot-embossed on the smooth outside surface by a TaC-coated tungsten carbide mold.

2. The touch panel as described in claim 1, wherein the tactile element has a first tactile element configured to be a ridge.

3. The touch panel for haptic touch display as described in claim 2, wherein the tactile element further has a second tactile element configured to be a convex shape.

4. A method for manufacturing a touch panel with a tactile overlay, comprising the steps of:
providing a pressing member made of glass material with a pressing surface having a predetermined shape for a haptic touch display;
providing a TaC-coated tungsten carbide mold including a upper mold, and a substrate mold with a tactile features;
hot-embossing the pressing member thereby obtaining a tactile overlay with a tactile element corresponding to the tactile features;
separating the tactile overlay from the TaC-coated tungsten carbide mold.

5. The method for manufacturing a touch panel with a tactile overlay as described in claim 4, wherein the tactile element has a first tactile element configured to be a ridge.

6. The method for manufacturing a touch panel with a tactile overlay as described in claim 5, wherein the tactile element further has a second tactile element configured to be a convex shape.

7. A haptic touch display, comprising the touch panel described in claim 1.
